(19) United States
(12) Patent Application Publication
(10) Pub. No.: US 2014/0103165 A1
(43) Pub. Date: Apr. 17, 2014

(54) Maneuvering and Stability Control System for Jet-Pack

(71) Applicant: Personal Water Craft Product, Le Rove (FR)

(72) Inventor: Frankie Zapata, Le Rove (FR)

(73) Assignee: Personal Water Craft Product, Le Rove (FR)

(21) Appl. No.: 14/049,725

(22) Filed: Oct. 9, 2013

Related U.S. Application Data
(60) Provisional application No. 61/711,306, filed on Oct. 9, 2012.

(51) Int. Cl. B64C 39/02

(52) U.S. Cl. CPC B64C 39/026
USPC 244/4 A

(57) ABSTRACT

To improve the maneuverability and stability of a jet-pack, the thrust of the nozzles is varied relative to one another, through a suitable valve arrangement. The ability to reduce the pressure on one side of the jet-pack enables much more flexible turns to be accomplished, and requires much less effort on the part of the passenger. Actuators, such as piston-cylinder arrangements, control the positioning of the nozzles and thereby assist the passenger in the piloting of the jet-pack. To further increase maneuverability, additional nozzles can be incorporated into the jet-pack to control the forward and backward tilt of the device, to more easily accomplish hovering, forward movement and backward movement.

### FIELD OF THE INVENTION

The present disclosure relates to a control system that provides improved maneuverability and stability of jet-packs that propel a passenger by means of a pressurized fluid expelled through one or more nozzles. In one embodiment, it is directed to such a jet-pack that is supplied with the pressurized fluid through a remote compressor station.

### BACKGROUND

In general, a jet-pack is a device that is designed to be strapped to the torso of a passenger, and propels the passenger, e.g. through the air, by means of a thrust that is generated by expelling a pressurized fluid through one or more nozzles on the jet-pack. Typically, the jet-pack has two nozzles respectively located on its right and left sides. The source of the thrust can be mounted on the jet-pack, for example a tank of pressurized gas, or it can be provided at a remote station. For example, the remote station can be located on a floating body that supplies pressurized water to the jet-pack via a conduit, and travels with the passenger suspended over the water by the thrust of the jet-pack.

The maneuverability of the jet-pack is controlled by adjusting the orientation of the nozzles. For example, the nozzles might be normally oriented to provide a downwardly vertical thrust, and thereby obtain maximum lifting force. Once the passenger has been lifted to a desired height, he or she can move forward by adjusting the nozzles to an inclined position that induces a component of rearwardly facing thrust. To turn, the passenger might cause one of the nozzles to move to an inclined position, while keeping the other nozzle in the vertical position. For example, to turn to the left, the passenger might cause the nozzle on the right side of the jet-pack to move to an inclined position that provides rearward thrust on the right side, thus inducing rotation to the left. However, this action reduces some of the downward thrust on the right side. With the left side maintaining full downward thrust, the resulting forces cause the passenger to tilt to the right, which is counterintuitive when turning to the left, and may cause instability. Consequently, it may be difficult for the passenger to learn how to properly maneuver the jet-pack.

### SUMMARY

To improve the maneuverability and stability of a jet-pack, in one embodiment according to the invention, the thrust of the nozzles can be varied, relative to one another, through a suitable valve arrangement. In one example, the valves can be flap valves that open and close to increase or decrease the amount of pressurized fluid flowing through each nozzle. The ability to reduce the pressure on one side or the other side of the jet-pack enables much more flexible turns to be accomplished, and requires much less effort on the part of the passenger.

In another aspect, the invention employs actuators, such as piston-cylinder arrangements, to control the positioning of the nozzles and thereby assist the passenger in the piloting of the jet-pack.

To further increase maneuverability, additional nozzles can be incorporated into the jet-pack to control the forward and backward tilt of the device, to more easily accomplish hovering, forward movement and backward movement.

In accordance with another aspect of the invention, a control system for actuating the valves and pistons can utilize position and/or acceleration sensors to assist in the maneuvering of the jet-pack. For instance, in the absence of a positive indication from the passenger to move in a particular direction, the sensors can cause the jet-pack to assume a default position, e.g. stationary hovering. Such a feature is particularly helpful for a novice passenger.

The foregoing features and advantages of the invention are explained in detail hereinafter with reference to exemplary embodiments illustrated in the accompanying figures.

### BRIEF DESCRIPTION OF THE DRAWINGS

FIG. 1 is a side view of a first embodiment of a jet-pack implementing features of the present invention;

FIG. 2 is a rear view of the first embodiment;

FIG. 3 is a rear view of a second, alternate embodiment of a jet-pack; and

FIG. 4 is a side view of a third embodiment of a jet-pack.

### DETAILED DESCRIPTION

To facilitate an understanding of the principles that underlie the disclosed invention, various embodiments are described with reference to a jet-pack that is supplied with a pressurized liquid from a remote source. Examples of this type of jet-pack are described in U.S. Pat. Nos. 3,277,858 and 7,258,301. It will be appreciated, however, that the applications of the invention are not limited to this particular type of jet-pack. Rather, it can be implemented in jet-packs having on-board sources of pressurized fluid, as well as those which receive a pressurized fluid from a remote source.

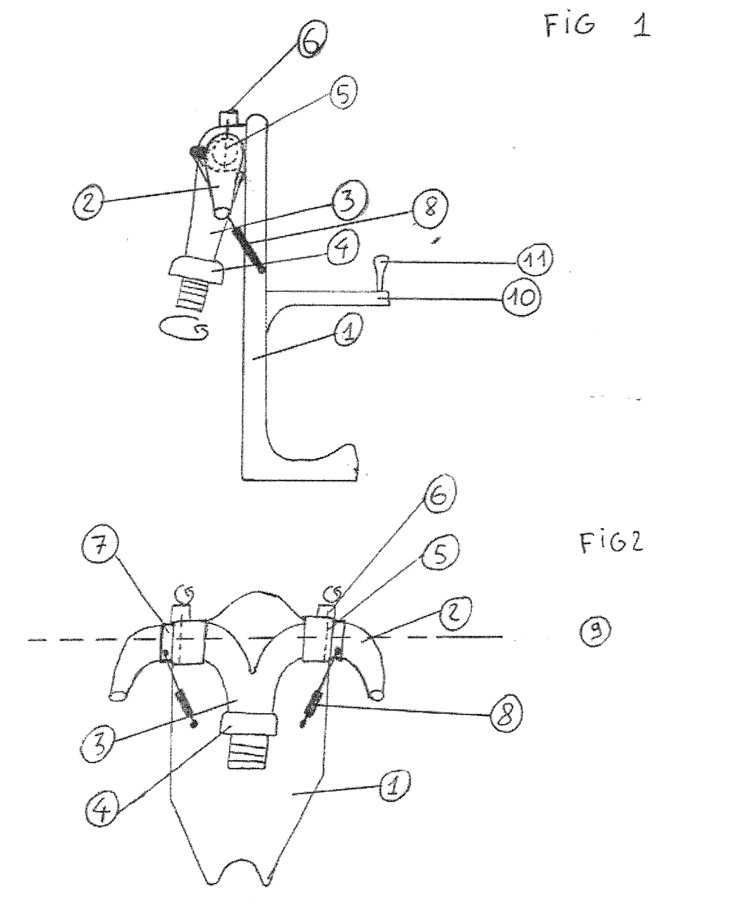

FIGS. 1 and 2 are a side view and a rear view, respectively, of a jet-pack that implements features of the present invention. The jet-pack includes a frame 1 to which the passenger is attached, for example by means of suitable straps (not shown). A pair of thrust nozzles 2 are mounted on the right and left sides at the back of the frame, to provide a lifting thrust for the frame and the passenger positioned thereon. Pressurized fluid is provided to the nozzles by means of a Y-shaped manifold 3 that divides the pressurized fluid into two flow paths associated with the nozzles. A rotatable coupler 4 enables one end of a fluid conduit, e.g. a flexible hose, to be attached to the manifold in a manner that permits the conduit to rotate relative to the manifold and the frame about the axis of the conduit. The other end of the conduit is attached to a remote compression station (not shown). In one implementation, the remote station can be a personal watercraft, e.g. a jet-ski, that is adapted to supply pressurized water to a conduit attached thereto.

A valve is located in the flow path of each nozzle 2, at the juncture of the nozzle with the manifold 3, to regulate the amount of pressurized fluid entering each nozzle. In one embodiment, the valve is implemented as a pivotable flap 5, similar in operation to the choke plate on a carburetor. In a normal position, the plane of the flap can be parallel to the direction of flow of the fluid from the manifold into the nozzle, to thereby obtain maximum thrust. An actuator 6 associated with each flap 5 causes the flap to pivot about an axis that is transverse to the direction of fluid flow, to partially close the valve and thereby reduce the amount of fluid flowing into the nozzle. In the illustrated embodiment, the flaps 5 pivot about a vertical axis, and the regulators 6 are positioned at the top of the juncture between the manifold and the nozzles. It will be appreciated that other arrangements, e.g. a horizontal pivot axis, are also feasible. By selectively activating one of the two actuators 6, the thrust on one side of the jet-pack can be reduced, relative to the thrust coming from the nozzle on the other side, to thereby cause the jet-pack to tilt to the right or left.

The nozzles 2 are connected to the manifold 3 by means of rotatable bearings 7, which enable the nozzles to independently pivot about a substantially horizontal axis 9, relative to the frame 1 and the manifold 3. The pivoting movement of the nozzles is effected by a pair of actuators 8 that are connected between the frame 1 and the nozzles. In the illustrated embodiment, the actuators comprise piston-cylinder mechanisms. When the pistons are contracted, the respective nozzles pivot in a counterclockwise direction, as viewed in FIG. 1, to induce a component of forward thrust that causes the jet-pack to move rearwardly. Conversely, when the pistons are extended, the nozzles pivot in a clockwise direction, inducing a component of rearward thrust that causes the jet-pack to move in a forward direction. If one piston is extended and the other is contracted, the jet-pack rotates about a substantially vertical axis.

In one embodiment, the control of the actuators 6 for the valves 5 and the cylinders 8 can be manually performed by the passenger, for example by cables, pulleys and/or gears connected to a lifter. In an alternate embodiment, the actuation is implemented by means of a controller with associated sensors to receive input signals from the passenger, and generate control signals to activate the actuators 6 and cylinders 8. For example, the frame 1 can be provided with an arm rest 10 that houses a joystick 11 for input of maneuvering commands. The joystick has sensors to detect forward, back, left and right movement of the joystick. The sensed motions are input to the controller (not shown). In response, the controller sends signals to the actuator 6 and the cylinder 8 to perform associated movements. For example, if the passenger pushes the joystick forward, the two cylinders 8 can be actuated to extend the pistons and thereby rotate the nozzles in the clockwise direction, to produce rearward thrust. Pulling rearwardly on the joystick causes the opposite reaction.

In one implementation, a small portion of the pressurized fluid in the manifold 3 can be used to hydraulically or pneumatically actuate the cylinders 8. A small diversion valve can be employed to direct the pressurized fluid to one end or the other of the cylinder, to thereby cause the piston to contract or expand. This diversion valve can have a small electric motor that is controlled by a signal from the controller. Similarly, the actuators 6 for the flap valves 5 can be small electric motors.

Pulling the joystick to one side or the other induces a turning motion in that direction. For example, if the joystick is pulled to the left to initiate a turn in that direction, the actuator 6 for the valve 5 on the left nozzle causes that valve to close a certain amount, thereby reducing the pressure in the left nozzle and tilting the passenger to the left. At the same time, the cylinder 8 for the right nozzle is actuated to extend, and thereby rotate that nozzle to the rear, which induces the turning motion. By this coordinated action of the valve 5 on one side and the cylinder 8 on the other side, the passenger undergoes a more natural movement, in which he or she leans in the direction of the turn.

The controller can be a simple logic controller that receives the sensed positions of the joystick and outputs appropriate control signals to the right and left valve actuators 6 and the left and right cylinder actuators 8. One example of the logic implemented by the controller is provided in the following table, where 11 represents the position of the joystick, 6R and 6L represent the right and left valve actuators 6, and 8R and 8L represent the right and left cylinder actuators 8.

| 11 | 6R | 6L | 8R | 8L | Resulting Action |
|---|---|---|---|---|---|
| F | — | — | E | E | Move Forward |
| B | — | — | T | T | Move Backward |
| R | C | — | — | E | Turn Right |
| L | — | C | E | — | Turn Left |

F = Forward, B = Back, R = Right, L = Left, E = Extend, T = Retract, C = Close

Thus, for instance, if the joystick is moved forward, the right and left cylinders 8 are actuated to extend the pistons, and thereby pivot the nozzles 2 rearwardly, to cause movement in a forward direction. If the joystick is pulled to the left, the left actuator 6 is activated to close the valve 5 and reduce the pressure in the left nozzle 2, while the right cylinder 8 is actuated to extend the piston and pivot the right nozzle 2 rearwardly, to effect a left turn. The symbol “C” indicating that a flap valve is to be closed does not necessarily mean that the valve is fully closed. In practice, the valve is only partially closed, to reduce the pressure in the associated nozzle to a desired level.

In an alternate embodiment, the jet-pack can be provided with left and right joysticks, one for each hand of the passenger. The two joysticks can independently control the pivoting of the respective nozzles 2. Pushing forward on one joystick while pulling backwards on the other causes the passenger to rotate in place.

The amount of thrust from the nozzles can be controlled by a throttle button or trigger (not shown) mounted on the joystick. Depression of the button or trigger sends a signal to the remote station, to increase the pressure of the fluid being supplied to the manifold 3, and thereby increase the thrust.

As a safety mechanism, the controller can be programmed with a default operation in the event that the passenger releases the joysticks. In such an event, each joystick returns to a center position, which causes the cylinders 8 to assume a neutral position in which the nozzles 2 are vertically oriented to provide a lifting thrust without forward or rearward movement. The controller can cause the actuators 6 to slowly close the valves 5, to thereby reduce the amount of thrust, and thereby provide a slow descent of the passenger to a safe landing. Alternatively, or in addition, the controller can send a signal to the remote station to gradually reduce the pressure of the fluid being supplied to the manifold 3.

As a further feature, the jet-pack can be equipped with one or more inflatable cushions to provide buoyancy in the case of a water landing. When the controller goes into the default operation, it can send a signal that causes the cushions to inflate, for example by opening compressed air cartridges.

FIG. 3 illustrates an alternative embodiment for changing the relative fluid pressure in the left and right nozzles. Rather than a separate valve associated with each nozzle, a single flap valve 5a, with an associated actuator 6, can be positioned at the point where the fluid from the conduit is divided into the left and right flow paths of the manifold 3. In the normal position, depicted by a solid line in FIG. 3, the flap of the valve is oriented parallel to the direction of fluid flow in the base portion of the manifold, so that the fluid is equally divided between the left and right flow paths. To change the relative pressure between the two nozzles, the flap can be pivoted to left or right positions, as depicted by the dashed lines, to increase the amount of fluid flowing through one nozzle, and concurrently decrease the amount of fluid flowing through the other nozzle.

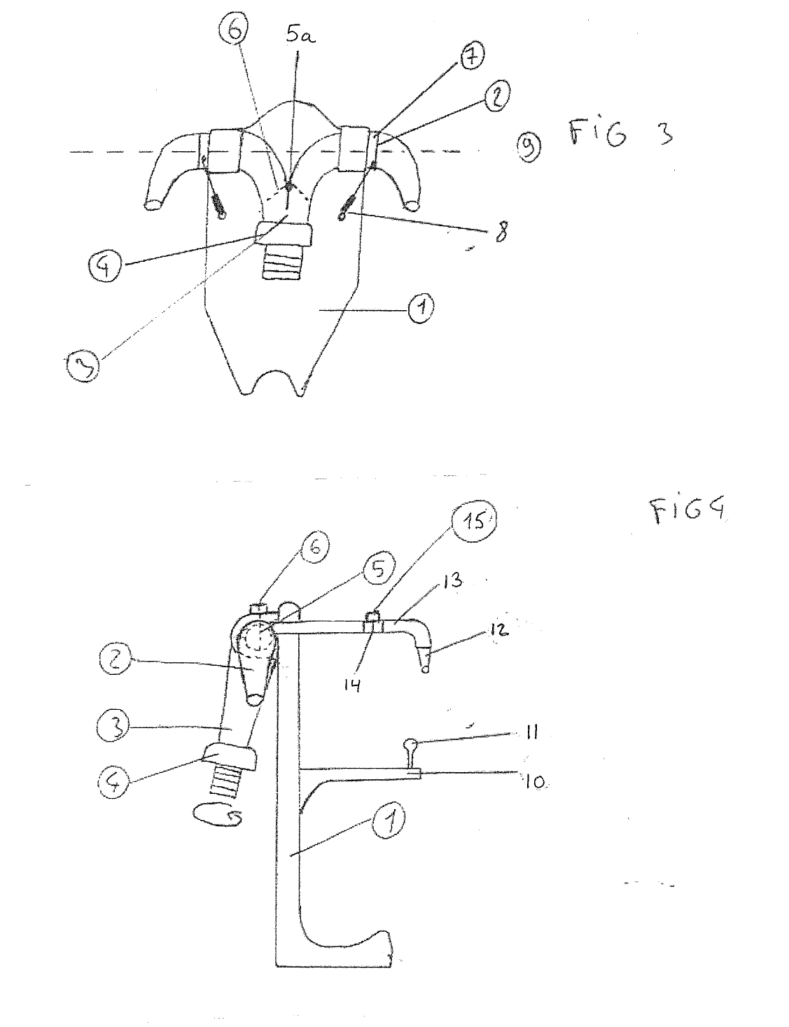

FIG. 4 illustrates a side view of another embodiment of the jet-pack. In this embodiment, two additional nozzles 12 are disposed at the end of respective tubes 13 that are connected to the left and right portions of the manifold. These tubes can be located outside the shoulders of the passenger. Each tube contains a flap valve 14, with an associated actuator 15. Regulating the amount of pressurized fluid flowing through the nozzles 12, through actuation of the flap valves 14, enables the passenger to control the forward and backward tilt of the jet-pack.

The control of the actuators 15 for the valves 14 can be coordinated with the pivoting motion of the nozzles 2. For example, if the passenger pushes forward on the joystick 11 to induce forward movement, the main nozzles 2 are pivoted clockwise, to provide rearward thrust. At the same time, the flap valves 14 can be closed, to reduce the thrust provide by the nozzles 12, allowing the jet-pack frame and the passenger to tilt forward. Conversely, when the joystick is pulled backward, the flap valves 14 can be opened to provide greater thrust through the nozzles 12, thereby tilting the frame backwards in conjunction with the backward movement of the jet-pack.

In the foregoing embodiments, the controls for maneuvering the jet-pack are located on the jet-pack itself, for actuation by the passenger. Alternatively, the controls can be located on the remote compressor station, to enable a trained operator to control the movement of the jet-pack, for example in the case of a novice passenger or a young child. The commands from the remote control station can be relayed to the respective actuators by means of an electrical cable located within the conduit that supplies the pressurized fluid.

What is claimed is:

1. A jet-pack, comprising:
a frame configured to be attached to the body of a passenger;
at least two nozzles respectively disposed on opposite sides of the frame;
a manifold that is connected to each of the two nozzles, and connectable to a source of pressurized fluid, for supplying the pressurized fluid along respective flow paths to the nozzles;
at least one valve disposed in the flow paths of the nozzles; and
a valve actuator responsive to a maneuvering command for actuating the valve to regulate the supply of pressurized fluid to at least one of the nozzles such that the pressure in one nozzle is less than the pressure in the other nozzle.

2. The jet-pack of claim 1, comprising at least two valves that are respectively disposed in the flow paths of the two nozzles, each of the valves having an associated valve actuator.

3. The jet-pack of claim 2, wherein the maneuvering command causes one of the two valves to close at least partially, to reduce the pressure in the nozzle associated with the one valve, relative to the pressure in the other nozzle.

4. The jet-pack of claim 1, wherein the manifold divides the pressurized fluid into two flow paths respectively associated with the two nozzles, and wherein the valve is disposed at a juncture of the two flow paths to selectively restrict the flow of pressurized fluid into one of the two flow paths.

5. The jet-pack of claim 1, wherein the nozzles are pivotable about a substantially horizontal axis relative to the frame, and further including a respective nozzle actuator connected to each nozzle for causing the nozzles to pivot independently of one another.

6. The jet-pack of claim 5, further including a controller that is responsive to maneuvering commands for controlling the valve actuators and the nozzle actuators.

7. The jet-pack of claim 6, wherein the controller is responsive to a turning command to activate the valve actuator to reduce the pressure in one of the nozzles, and to activate the nozzle actuator of the other nozzle to cause the other nozzle to pivot.

8. The jet-pack of claim 6 further including a command input device for the passenger to input the maneuvering commands.

9. The jet-pack of claim 9, wherein the command input device is a joystick.

10. The jet-pack of claim 6, wherein the maneuvering commands are received from a source that is remote from the jet-pack.
